(19) United States
(12) Patent Application Publication
(10) Pub. No.: US 2003/0209359 A1
(43) Pub. Date: Nov. 13, 2003

(54) Water seal for electrical conduit

(76) Inventor: Robert W. Baker, Spring, TX (US)

Correspondence Address: BAKER BOTTS, LLP, 910 LOUISIANA, HOUSTON, TX, 77002-4995, US

(21) Appl. No.: 10/141,445

(22) Filed: May 8, 2002

(51) Int. Cl. H02G 3/18

(52) U.S. Cl. 174/65 G

(57) ABSTRACT

A water seal between insulated electrical conductors connected to an underwater device such as a light and the entrance to a conduit containing the conductors is provided. The seal may be installed in existing pools when electrical cable is run through a conduit to the pool or may be installed over existing electrical cable passing through a conduit to a pool by using a split plug. The seal may also be provided by the manufacturer of apparatus for use in pools by forming a plug at a selected position on electrical cable that is attached and sealed to an electrical device such as a light.

### BACKGROUND OF THE INVENTION

1. Field of the Invention

This invention pertains to electrical fixtures in pools. More particularly, a water seal between insulated electrical cable and the interior wall of a conduit leading to an electrical fixture in a pool and methods for use are provided.

2. Description of Related Art

Swimming pools and other man-made pools are often lighted with underwater lighting fixtures. Insulated electrical cable from an electrical service box to the fixture is usually run through a conduit made of plastic and is molded or otherwise sealed into the light or other device where the cable containing conductors enters the device. A housing of the fixture forms a niche for the light or other device in the wall of the pool. The housing may not be sealed to prevent water from the pool entering the housing. If the conduit containing the electrical cable and other conductors is not sealed against water entry, water is then confined to the pool by the section of conduit that is placed below the water level in the pool. This conduit is usually laid below a deck or other ground-level surface around a pool, which means that the conduit may extend a considerable distance below the water level in the pool. Such conduits are sometimes damaged during or after construction of a pool, and it is not uncommon for water to leak from a pool through a conduit below ground level. The leak may cause collateral damage to the pool or its surroundings that is expensive to repair.

In an attempt to seal the end of conduit entering a pool, silicone rubber or putty is sometimes placed around electrical conductors entering the pool. The problems arising from use of such materials are that removal of the electrical conductors or the fixture for repair or replacement then becomes difficult and time-consuming. Also, the seal may not be effective.

What is needed is an inexpensive, effective seal that may be placed around electrical conductors entering a pool below water level. The plug or seal should be available, for examples, as an integral part of conductors attached to lights or other devices to be used in the new construction or replacement market, for placement around conductors that are being installed, for placement around conductors that are already in place in a conduit, or as a plug to be placed between insulated conductors and a conduit as a replacement part for a plug that failed.

### DESCRIPTION OF THE FIGURES

FIG. 1 shows a cross-section elevation view of an electrical fixture below water level in a pool with a conduit containing insulated electrical conductors and one embodiment of the seal disclosed herein.

FIG. 2 shows an embodiment of the seal disclosed herein having a corrugated surface.

FIG. 2A shows an embodiment of the seal disclosed herein molded to insulated electrical cables passing therethrough.

FIG. 3 shows an embodiment of the split seal disclosed herein having a corrugated surface.

FIG. 4 shows an embodiment of the seal disclosed herein having a smooth cylindrical surface with o-ring grooves.

FIG. 5 shows an embodiment of the split seal disclosed herein having a smooth cylindrical surface.

FIG. 6 shows a sub-assembly of a corrugated seal disclosed herein in the end of a conduit with an adapter attached to the conduit.

FIG. 7 shows a sub-assembly of a smooth and tapered cylindrical seal disclosed herein held in place by a cap.

FIG. 8 shows a cross-section elevation view of an electrical fixture below water level in a pool with a conduit containing insulated electrical conductors and a second embodiment of the seal disclosed herein.

### SUMMARY OF THE INVENTION

A plug to form a water seal between a conduit and electrical cable passing through the conduit is provided. The plug includes a cylinder and one or more openings through the cylinder for electrical cable. The cylinder and openings are sized so as to form a water seal between the electrical cable and the conduit. The outside surface of the cylinder may be corrugated. The plug may be formed from a deformable material or may be formed from a rigid material with deformable material such as an o-ring used to seal. The cylinder may be split so that it can be installed around cable already present in a conduit.

In another embodiment, the plug seal is manufactured as part of electrical apparatus. The plug seal may be placed on electrical cable so as to allow easy removal or maintenance of apparatus in a pool. Methods for installing the seal in new or existing applications are provided.

### DESCRIPTION OF PREFERRED EMBODIMENTS

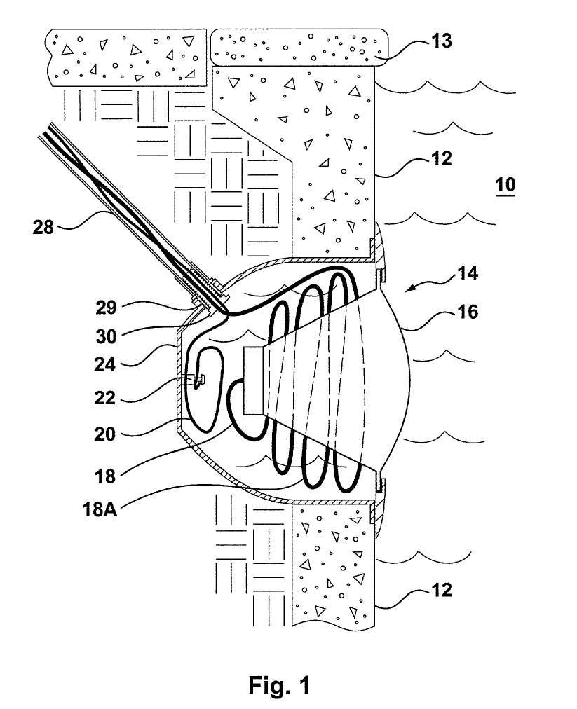

Referring to FIG. 1, water 10 is contained in a pool such as a swimming pool or other man-made pool having a wall or side such as side 12, which may be formed of concrete or other material. Fixture 14 is mounted in wall 12. Fixture 14 may be a lighting fixture, as shown, or may be any other device employing electrical power or an electrical signal, such as a pump or a controller. In FIG. 1, fixture 14 includes light 16, which is connected to cable 18 which is formed by insulated electrical conductors. Normally, cable 18 is molded into the base of light 16 so as to electrically insulate the connection between cable 18 and light 16. An installer normally provides extra loops of cable 18, shown as 18A, within housing 24 so as to allow removal of light 16 from fixture 14 and placement of light 16 on deck 13 for repair, such as replacement of a light bulb, or inspection. Ground wire 20 is attached to clamp 22 on housing 24 of fixture 14. Conduit 28 contains conductors 18 and 20 and normally extends to an electrical service box in a location remote to fixture 14. Conduit 28 is sealed to housing 24 by seal 29. Plug 30, disclosed herein, may be used to seal the entrance to conduit 28 to prevent water 10, normally at a level above fixture 14, entering conduit 28. Plug 30 may seal with the inside surface of conduit 28 or with any extension, adapter attached to conduit 28, or other connection with conduit 28. It should be understood that sealing inside any such attachment to conduit 28, such as an adapter or a housing of a niche, will be considered as sealing with the inside surface of conduit 28 and any such extension or attachment to a conduit where it is contiguous with a pool may be considered as a part of the conduit.

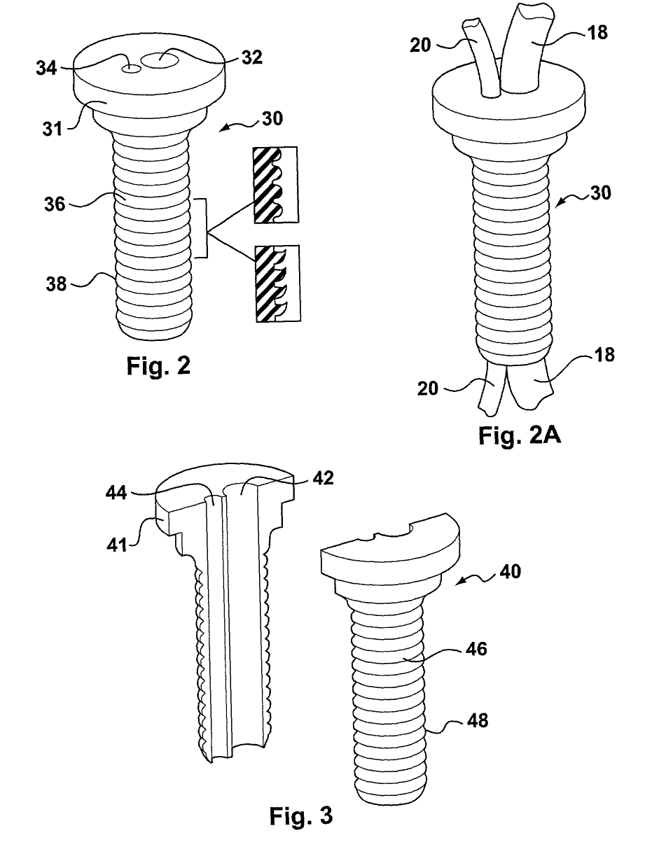

Referring to FIG. 2, one embodiment of seal or plug 30 is shown. Opening 32 is provided for an insulated cable, such as cable 18 of FIG. 1, and opening 34 is provided for a second conductor, such as ground wire 20 of FIG. 1. Head 31 (FIG. 2) is adapted to assist in placement and removal of plug 30 from a conduit. Cylinder 36 of plug 30 is adaptably sized for sealing in an electrical conduit. Sealing surface 38 may be corrugated (as shown) to assist in sealing after insertion into a conduit. Corrugations may be rounded, as shown in one inset, or may have other profiles, such as the directional fins shown in the second inset of FIG. 2. Plug 30 may be installed on cable or wire such as shown in FIG. 1 by sliding the plug from the end of the cable or wire that will be attached to electrical service to a position very near (within about 1 foot) where cable 18 enters into a fixture such as light 16 (FIG. 1). Alternatively, seal 30 may be placed at a position about 3 to 5 feet from the entry of the cable into a fixture. This 3 to 5 feet allows loops 18A to be formed in housing 34. Alternatively, seal or plug 30 may be molded or otherwise sealed permanently onto cable 18 and ground wire 20 during manufacture of a fixture such as light 16, such as shown in FIG. 2A. Plug 30 may be permanently affixed very near or at a selected distance from the entry of cable 18 into light 16, so as to allow loops such as shown at 18A to be formed in cable 18 within a housing. An installer of a fixture then may insert cables 18 and 20 into a conduit where it is contiguous with a pool and pulls cables 18 and 20 through a conduit until plug 30 can be inserted into the end of the conduit.

Plug 30 may be formed from a deformable material, such as an elastomeric material, such as rubber. Alternatively, plug 30 may be formed of other polymeric material. A liquid that cures to an elastomeric material or a grease may be applied to plug 30 before or after deployment of the plug into a conduit.

Referring to FIG. 3, plug 40 is a split plug similar to plug 30 of FIG. 1. Head 41 is adapted to insertion or removal of plug 40 into a conduit. Openings 42 and 44, intersected by the split surface, are adapted to enclose electrical cable or wire such as described above. Half-cylinder 46 is adapted to mate with a matching half-cylinder in a conduit. Surface 48 may be corrugated in the shape shown in FIG. 3 or may have other shapes such as shown in the inset of FIG. 2. Plug 40 may be used to add a plug in a conduit to an existing pool without removing cable or wire from the conduit leading to the pool. This addition may be particularly important if a water leak is identified or suspected in the conduit.

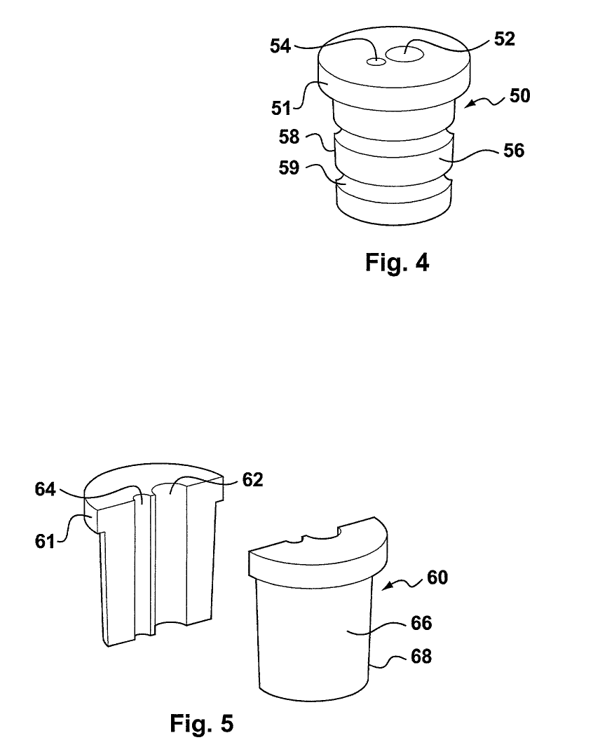

Referring to FIG. 4, plug 50 is shown, which contains head 51 and openings 52 and 54. Cylinder 56 is adapted for use in a selected conduit size and may be formed from a deformable material such as rubber. Cylindrical surface 58 may be smooth and may be tapered to a smaller diameter at the end. Alternatively, plug 50 having cylinder 56 may be formed from a rigid material such as metal and surface 58 may contain one or more o-ring grooves 59, which are adapted to receive o-rings for sealing inside a selected conduit. O-ring grooves may also be placed in openings 52 and 54 (not shown) for sealing around cables.

Referring to FIG. 5, a split version of plug 50 (without o-ring grooves) is shown as matching half-cylinders 60. Head 61 and half-cylinder openings 62 and 64, intersected by the split, are adapted to enclose cables or wire. Half-cylinders 66 are adapted to seal inside a conduit. Surface 68 may be smooth. Plug 60 may be formed of a deformable material.

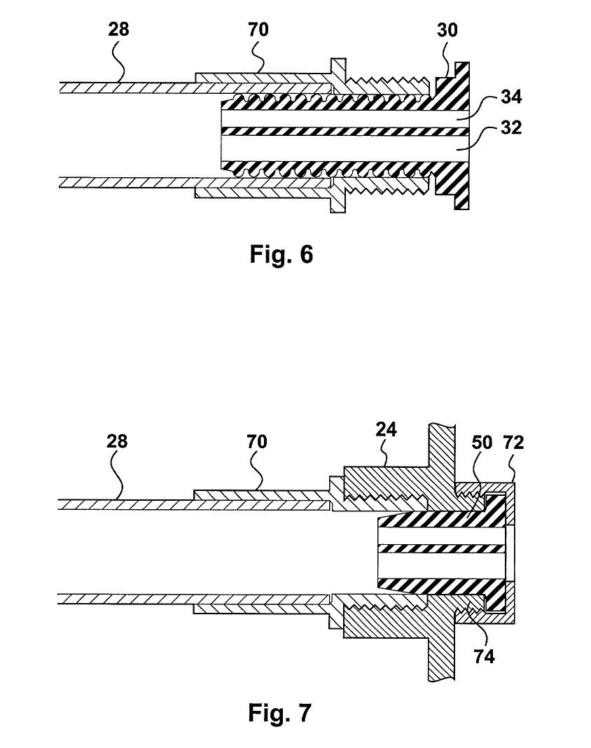

Referring to FIG. 6, plug 30 in the end of conduit 28 is shown. Adapter 70 is preferably attached to the end of conduit 28 before housing 24 is installed (FIG. 1). It may be attached by an adhesive. Electrical conductors are passed through openings 32 and 34 before plug 30 is installed in conduit 28.

Referring to FIG. 7, housing 24 is attached to adapter 70. In one embodiment, housing 24 is formed to include a male connector, such as threads, inside the niche formed by housing 24. Plug 50, which is shown as having a tapered cylindrical surface, is then inserted in the end of conduit 28 and cap 72, which may be threadably attached to housing 24, may be installed. Cap 72 may force plug 50 into housing 24 and adapter 70 and increase the sealing force between a tapered surface of plug 50 and the internal surface of housing 24 or adapter 70 and cables passing therethrough.

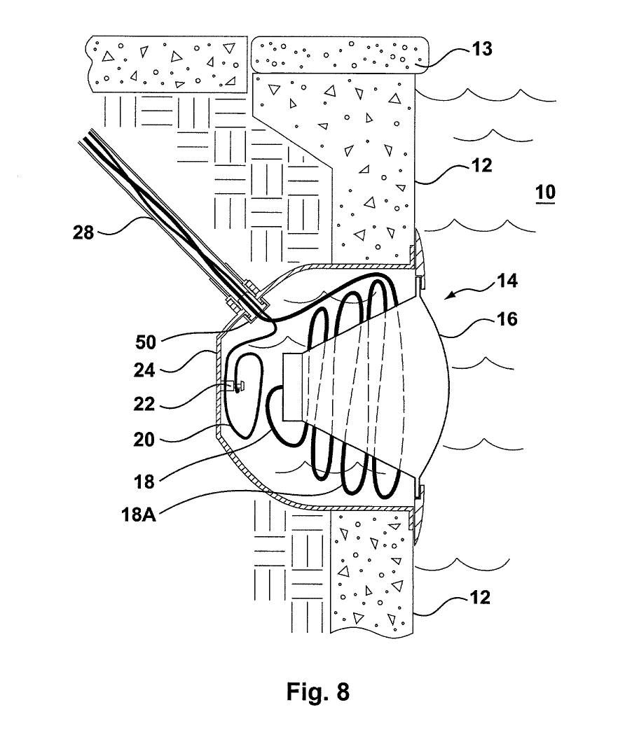

FIG. 8 is a composite drawing such as in FIG. 1, showing plug 50 in place of plug 30. It should be understood that any of the plugs described herein may be used as shown in FIG. 1 and FIG. 8.

While the invention has been described with respect to some preferred embodiments, it should be understood that the invention is limited only by the scope of the claims below.

What I claim is:

1. A plug to form a water seal between a selected conduit having an inner surface and a selected electrical cable passing through the conduit, comprising:
a cylinder having end surfaces, a cylindrical surface, and a diameter adapted to place the cylindrical surface in sealing contact with the inner surface of the selected conduit; and
a cylindrical opening passing through the cylinder in a direction so as to intersect the end surfaces, the cylindrical opening having a diameter adapted to place the cylindrical opening in sealing contact with the selected electrical cable.

2. The plug of claim 1 wherein a plurality of cylindrical openings pass through the cylinder in a direction so as to intersect the end surfaces, each cylindrical opening having a diameter adapted to place an electrical cable in sealing contact with the cylindrical opening.

3. The plug of claim 1 wherein the cylindrical surface is corrugated.

4. The plug of claim 1 wherein the cylinder is formed of a deformable material.

5. The plug of claim 4 wherein the deformable material is rubber.

6. The plug of claim 1 wherein the cylinder is formed of a rigid material.

7. The plug of claim 6 further comprising an o-ring groove in the cylindrical surface and the cylindrical opening.

8. The plug of claim 1 wherein the cylinder is split, a surface formed by the split passing through the cylindrical opening.

9. The plug of claim 2 wherein the cylinder is split, a surface formed by the split passing through the plurality of cylindrical openings.

10. The plug of claim 1 wherein the cylindrical surface is tapered.

11. Apparatus for underwater lighting, comprising:
a light;
an electrical cable and an electrical connection between the cable and the light, the connection being sealed and electrically insulated from a surrounding liquid;
a plug formed and sealed around the electrical cable at a selected distance from the connection, the plug having a cylindrical surface and being adapted to form a water seal between a conduit having a selected inside diameter and the cylindrical surface of the plug.

12. The apparatus of claim 11 wherein the selected distance is in the range from about 3 feet to about 5 feet.

13. The apparatus of claim 11 wherein the cylindrical surface of the plug is corrugated.

14. The apparatus of claim 11 wherein the plug is formed of a deformable material.

15. The apparatus of claim 11 wherein the cylindrical surface is tapered.

16. A method for sealing between a conduit contiguous with a pool and one or more electrical cables, the electrical cables having a first end and a second end, the second end terminating in a sealed connection to an electrical device, comprising:
placing a plug, the plug being the plug of claim 1 or claim 2, around the first end of the electrical cable and sliding the plug along the cable or cables to a selected position spaced apart from the second end by a selected distance; and
placing the electrical cable in the conduit and inserting the plug in the conduit.

17. A method for sealing between a conduit contiguous with a pool and an electrical cable, the electrical cable having a first end and a second end, the second end terminating in a sealed connection to an electrical device and extending through the conduit, comprising:
placing a plug, the plug being the plug of claim 8, claim 9 or claim 10 around the electrical cable at a selected position and inserting the plug into the conduit.

18. The method of claim 17 further comprising the step of placing a cap over the plug.

19. A method for sealing between a conduit contiguous with a pool and an electrical cable, comprising:
inserting the electrical cable of the apparatus of claim 11 in the conduit where the conduit is contiguous with the pool and inserting the plug of the apparatus of claim 11 in the conduit.
